(19) United States
(12) Patent Application Publication
(10) Pub. No.: US 2009/0154886 A1
(43) Pub. Date: Jun. 18, 2009

(54) Multi-zone scanned-beam imager

(75) Inventors: John R. Lewis, Bellevue, WA (US); Christopher A. Wiklof, Everett, WA (US)

Correspondence Address: MICROVISION, INC., 6222 185TH AVENUE NE, REDMOND, WA, 98052, US

(73) Assignee: Microvision, Inc.

(21) Appl. No.: 12/002,146

(22) Filed: Dec. 13, 2007

(51) Int. Cl. G02B 6/06; G02B 26/08

(52) U.S. Cl. 385/117

(57) ABSTRACT

Embodiments relate to scanning a plurality of light beams across a corresponding plurality of zones in a field of view and collecting scattered light to enable an image of the field of view to be formed that spans the plurality of zones. According to an embodiment, a scanning endoscope tip may include structures configured to launch the plurality of scanned beams toward respective zones and receive separate light scattered from the respective beams impinging upon the respective zones. According to an embodiment, an image processor is operable to receive detection signals from corresponding light detectors and reconstruct an image of the field of view spanning the plurality of zones.

### BACKGROUND

In a scanned-beam imaging system such as a scanned beam endoscope, image resolution, and hence image quality, may depend on the number of pixels captured in the time allotted to acquire an image or frame. A scanned-beam system may operate, for example, by directing a narrow beam of light across a field of view in a scan pattern calculated to cover substantially the entire field of view in a frame period. The pattern may comprise a raster pattern (e.g., similar to how a television displays images), a bi-sinusoidal pattern, or some other pattern.

To increase the resolution, the frame rate may be reduced (or equivalently, the frame period may be increased) or the beam scan speed may be increased while the scan pattern (and optionally, the beam diameter) is adjusted to capture more pixels within the field of view. However, reducing the frame rate may result in decreased temporal resolution and can increase the incidence of image “smearing” artifacts related to the movement during the lengthened frame period. Conversely, increasing the beam scan speed may reduce the amount of time available to receive photons associated with each pixel, and thus may increase pixel noise or brightness uncertainty, may increase electronic noise, may place constraints on light collection area and/or detector size, may require higher power light sources, and/or may otherwise hinder other aspects of scanned beam imager cost, size, or performance, for example. Additionally, increasing the beam scan speed may place additional constraints on the beam scanning mechanism that may be difficult or impossible to meet.

### OVERVIEW

According to an embodiment, a scanned-beam endoscope may scan a plurality of beams across two or more regions or zones comprising a field of view. The two or more zones may be substantially non-overlapping, or alternatively may overlap at least somewhat.

According to an embodiment, the scanned-beam system may include two or more light sources and/or optical fibers configured to launch two or more corresponding beams of light onto a beam scanner from differing angles. The separately launched beams may then be scanned across respective zones of the field of view by the beam scanner.

According to an embodiment, light from the respective scanned beams scattered from objects in the field of view may be de-scanned by the beam scanner and collected retro-reflectively along the respective beam launch axes. According to another embodiment, light scattered from within the respective zones of the field of view may be collected by vignetted or directional staring collection optics.

According to another embodiment, a scanned beam system may comprise a light source operable to launch a beam of light, an optical element aligned to receive the beam and configured to divide the beam into a plurality of beams or beamlets, and a scanner configured to scan the beam, the plurality of beams, or the beamlets, whereby a plurality of beams are scanned across respective zones of a field of view.

By increasing the number of light beams scanned across zones of a field of view and providing light collectors and/or detectors configured to receive scattered light from the respective zones, the rate of pixel collection may be increased without necessarily increasing the scanning rate of the beam scanner or decreasing the frame rate.

### BRIEF DESCRIPTION OF THE DRAWINGS

FIG. 1 is a block diagram that represents a scanned-beam system according to an embodiment.

FIG. 2 is a diagram that generally represents a portion of a scanned-beam system according to an embodiment.

FIG. 3A is a diagram illustrating a structure for generating a plurality of scanning beams, according to an embodiment.

FIG. 3B is a diagram illustrating a structure for generating a plurality of scanning beams, according to another embodiment.

FIG. 3C is a diagram illustrating a structure for generating a plurality of scanning beams, according to another embodiment.

FIG. 3D is a diagram illustrating a structure for generating a plurality of scanning beams, according to another embodiment.

FIG. 3E is a diagram illustrating a structure for generating a plurality of scanning beams, according to another embodiment.

FIG. 3F is a diagram illustrating a structure for generating a plurality of scanning beams, according to another embodiment.

FIG. 3G is a diagram illustrating a structure for generating a plurality of scanning beams, according to another embodiment.

FIG. 4A is a diagram illustrating a relationship between scanning zones and detection zones at a first instant in time, according to an embodiment.

FIG. 4B is a diagram of the scanning zones and detection zones of FIG. 4A at a second instant in time, according to an embodiment.

FIG. 4C is a diagram of the scanning zones and detection zones of FIG. 4A at a third instant in time, according to an embodiment.

FIG. 5 is a side view of an illustrative detector that detects light from a specific field of view according to an embodiment.

FIG. 6 is a diagram that generally represents another illustrative mechanism for detecting light from various fields of view according to an embodiment.

FIG. 7 is a side view of an illustrative optical element for splitting light into beamlets according to an embodiment.

FIG. 8 is a side view of another illustrative optical element for splitting light into beamlets according to an embodiment.

FIG. 9 is a side view of another illustrative optical element for splitting light into beamlets according to another embodiment.

### DETAILED DESCRIPTION

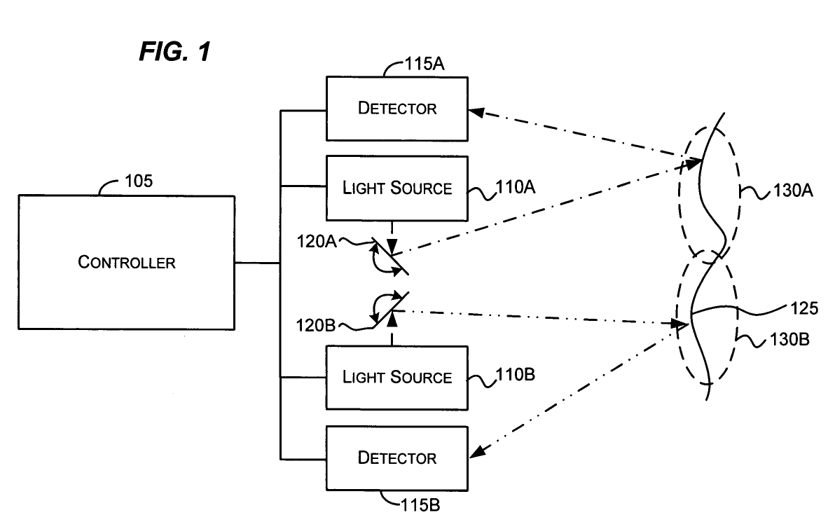

FIG. 1 is a block diagram that represents a scanned-beam system according to an embodiment. The system includes a controller 105 operatively coupled to light sources 110A and 110B, detectors 115A and 115B, and scanners (also referred to as light directing elements) 120A and 120B. Among other things, the controller 105 may provide light source drive signals operative to vary the intensity of the light sources 110A and 110B as well as signals operative to vary the sensitivity of the detectors 115A and 115B. In addition, the controller 105 may provide scanner drive signals operative to control the scanners 120A and 120B, and hence cause the light transmitted from the light sources 110A and 110B to be scanned across a field of view 125. In some embodiments, the scanners 120A and 120B may oscillate at a known or selectable frequency (which may be the same or different from each other). In an embodiment, the frequency is near or substantially at a resonant frequency of the scanner.

According to another embodiment, one scanner 120A may be aligned to receive a plurality of beams of light and the second scanner 120B may be omitted.

Scanned light that scatters from the field of view 125 may be detected by the detectors 115A and 115B. The detectors 115A and 115B may generate signals corresponding to the light scattered from the field of view 125. The signals may then be sent to the controller 105 and used to generate an image frame that corresponds to substantially all or a portion of the field of view 125.

Images may be detected at a specified or selected frame rate. For example, in an embodiment, images are detected and converted into frames at a rate of 30 frames per second.

The controller 105 may optionally modulate light source drive signals to drive the light sources 110A and 110B at a relatively low rate (i.e., relative to a scanning frequency) to emit beams of light corresponding to one or more selected zones of a periodic scan pattern. Accordingly, a sequence of field of view zones may be scanned with the periodic scan pattern. Alternatively, the controller 105 may modulate the light source drive signals at a rate substantially higher than a fast scan frequency of the one or more scanners 120A, 120B to selectively illuminate pixels in various zones of the field of view corresponding to the plurality of scanned beams. Thus, embodiments may alternatively provide time-sequenced frame detection of the scanned zones of the field of view, time-sequenced line detection across plural zones, or time-sequenced pixel detection across the plural zones. According to embodiments, time-sequencing of light received from a plurality of zones may allow the use of a one detector 115A configured to view substantially the entire field of view to receive the time-sequenced image information carried by light scattered from the zones.

In accordance with aspects of the subject matter described herein, in some embodiments, light (sometimes referred to as a “light beam”) comprises visible light. In other embodiments, light comprises radiation detectable by the detectors 115A and 115B and may include one or more of infrared, ultraviolet, and visible.

Light from the light sources 110A and 110B may be transmitted toward the scanners 120A and 120B via an optical element such as one or more optical fibers. In an embodiment, a light source (e.g., light source 120A or 120B) may generate a plurality of wavelengths (e.g., red, blue, and green) that are combined to form a composite beam that is scanned across a zone 130A, 130B of the field of view 125. In some embodiments, a light source may generate other combinations of wavelengths, for example including red, blue, green, and cyan. This may be used to create a 4-channel system with improved color gamut. In yet other aspects, a light source may generate light in the infrared, ultraviolet, or other electromagnetic frequency which may be combined to form an extended spectrum system.

In an embodiment, a light source may generate light having various other properties. For example, a light source may generate a light beam composed of two red wavelengths differing from each other by several nanometers. This embodiment may be used to improve discrimination between red objects such as blood cells, for example.

In other embodiments, light wavelengths having therapeutic properties may be selectively launched, such as to be used for treatment. For example, infrared light may be used to cauterize or oblate, ultraviolet light may be used to enable phototropic drugs, modify skin texture, etc. A combination of narrow wavelength light sources may be used to avoid exposure to unwanted wavelengths, for instance when a phototropic drug is present, but it is desired to activate it only in certain cases. Therapeutic beams may be selectively enabled by a physician or remote export, or alternatively may be automatically enabled based on image properties. Therapeutic beams may be enabled for an entire field of view, for a portion of the field of view including specific, small spots within the field of view.

In an embodiment, a light beam created from a light source may be passed through an aperture in the center of a scanning mirror, bounced off a reflector, returned to the scanning mirror, and then scanned across a scanning zone. This concentric beam path may be used to reduce the size of an imaging tip for use in inserting into a body cavity or other constricted area. In addition, polarization properties of the beam and relevant hardware may be manipulated to maximize signal strength and minimize stray light that reaches the field of view.

Although two light sources are shown in FIG. 1, the light sources 110A and 110B may be combined into one light source. The light from the combined light source may be split into multiple beams and scanned across multiple areas (e.g., areas 130A and 130B) as described below. According to some embodiments, the areas 130A and 130B may overlap.

In an embodiment, detectors may comprise non-imaging detectors. That is, the detectors may operate without the use of an aperture or other optical device that forms an image from the received light on a focal plane such as a conjugate image plane. According to an embodiment, a light sensor array such as a CCD array, a CMOS array, or the like, may be coupled such that any one sensor receives light from several spots within a detection zone. Thus, embodiments taught herein may be used to multiply the resolution of a sensor array.

The detectors 115A and 115B may receive light scattered from corresponding detection zones 130A and 130B. That is, each detector may be arranged such that it receives and detects light that is scattered from a corresponding detection zone. To limit scattered light reaching a given detector to light from substantially a single detection zone, each light receiver may be configured with a numerical aperture sufficiently large to receive light from the entirety of an assigned zone, but sufficiently small to substantially exclude light from other zones. For embodiments such as a scanning endoscope, the light collectors (not shown) may comprise optical fibers that relay light received at a scanning tip to a remote detector. In other embodiments, the detectors may be placed sufficiently near the field of view to receive light from the field of view substantially directly. To exclude light from unwanted zones, the numerical aperture of the detector fibers may be selected to have relatively narrow collection cones. Additionally or alternatively, other structures such as microlens arrays, light baffles, etc. may be used to create a blind between neighboring zones.

Based on the location to which a scanner was directing light at or near the time the light reaches its corresponding detector, light detected by a detector may be attributed to a spot in the field of view 125 and assigned to a pixel (e.g., via the controller 105, a portion thereof, or other circuitry) and may be used together with light detected from other spots to form an image. In an embodiment, the detectors 115A and 115B may comprise photodiodes or other light-sensitive elements that are aligned to receive light substantially directly from the FOV. In other embodiments, the detectors 115A and 115B may receive light from optical fibers that collect light and transmit it to the detectors 115A and 115B, where it is converted into electrical signals for further processing. Such gathering fibers may be arranged circumferentially around the scanners 120A and 120B, for example.

In an embodiment, light may be collected retrocollectively, with scanners being used to gather and de-scan light that received from the field of view. For example, light that scatters from the surface 125 or travels other paths may travel back to the scanners 120A and 120B. This light may then be directed to the detectors and used to construct an image. In one embodiment, collection fibers may be arranged across the tip of a device transmitting light from the light sources 110A and 110B. The collection fibers may be arranged in interstitial spaces between irrigation channels, working channels, and the like, for example. The tip of the device may be made partially translucent or transparent to increase the area over which light may be gathered.

The controller 105 may comprise one or more application-specific integrated circuits (ASICs), discrete components, embedded controllers, general or special purpose processors, combinations of the above, and the like. In some embodiments, the functions of the controller 105 may be performed by various components. For example, the controller may include hardware components that interface with the light sources 110A and 110B and the detectors 115A and 115B, hardware components (e.g., such as a processor or ASIC) that performs calculations based on received signal, and software components (e.g., software, firmware, circuit structures, and the like) encoding instructions that a processor or the like executes to perform calculations. These components may be included on a single device or distributed across more than one device without departing from the spirit or scope of the subject matter described herein.

In an embodiment, at least part of the scanned-beam system is part of a camera, video recorder, document scanner, endoscope, laparoscope, boroscope, machine vision camera, other image capturing device, or the like. In an embodiment, the scanned-beam system may comprise a microelectromechanical (MEMS) scanner that operates in a progressive or bi-sinusoidal scan pattern. In other embodiments, the scanned-beam system may comprise a scanner having electrical, mechanical, optical, fluid, other components, a combination thereof, or the like that is capable of directing light in a pattern. According to an embodiment, the scanner may be operable to move an optical fiber in a pattern with a beam of light being directed toward a spot or spots according to the angle or position made by the fiber tip as it is vibrated.

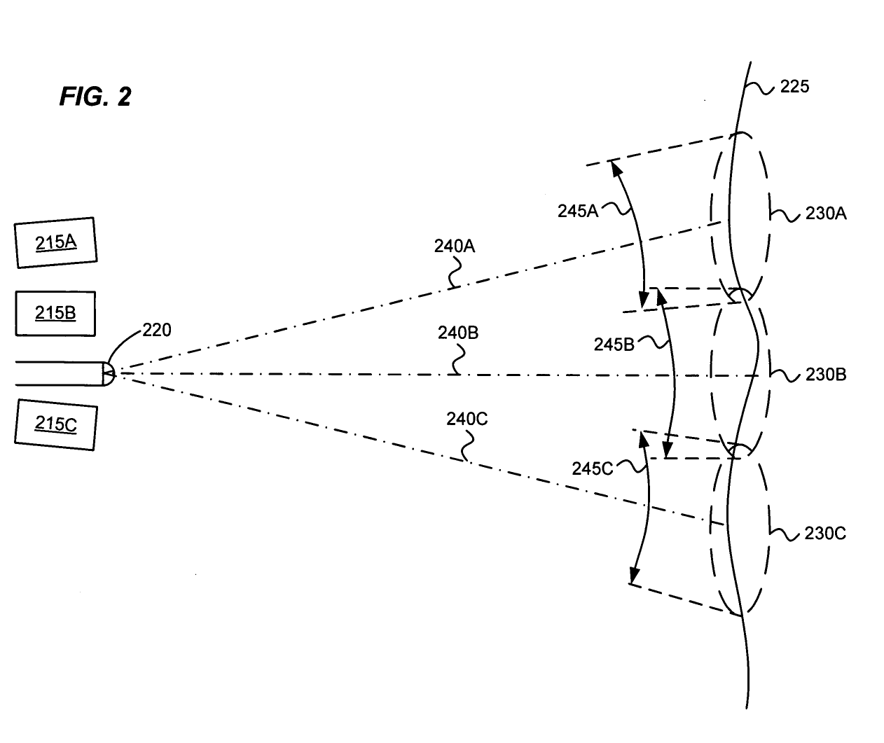

FIG. 2 is a diagram that generally represents a portion of a scanned-beam system according to an embodiment. The system includes a single scanner 220 that scans a plurality of light beams 240A-C across areas 230A-C, respectively. According to embodiments, the light beams 240A-C may comprise beamlets. The detectors 215A-215C are aligned and structured to detect light scattered from areas 230A-C, respectively. The detectors 215A-215C may be placed in other orientations than that shown as long as they are aligned to detect light substantially from their corresponding detection zones. For example, the detectors 215A-215C may be placed around the scanner 220.

The scanner 220 scans the light beams 240A-C in unison such that the light beams 240A-C scan over their respective areas 230A-230C. The scan amplitudes 245A-C may be selected such that the areas overlap to provide sufficient coverage of the field of view 225.

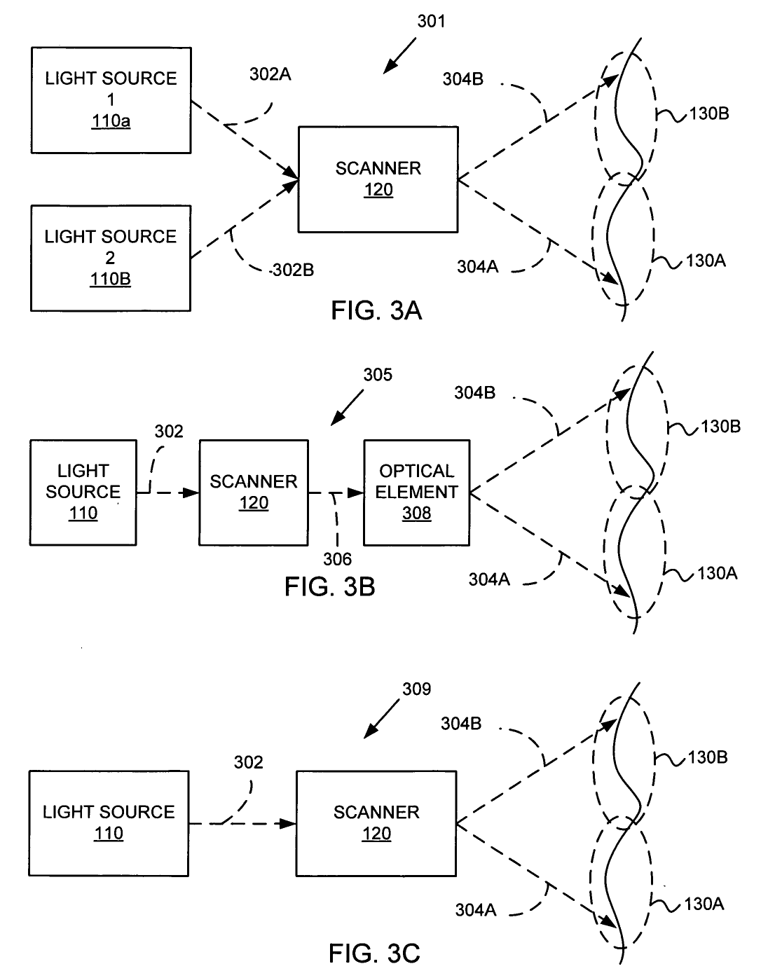

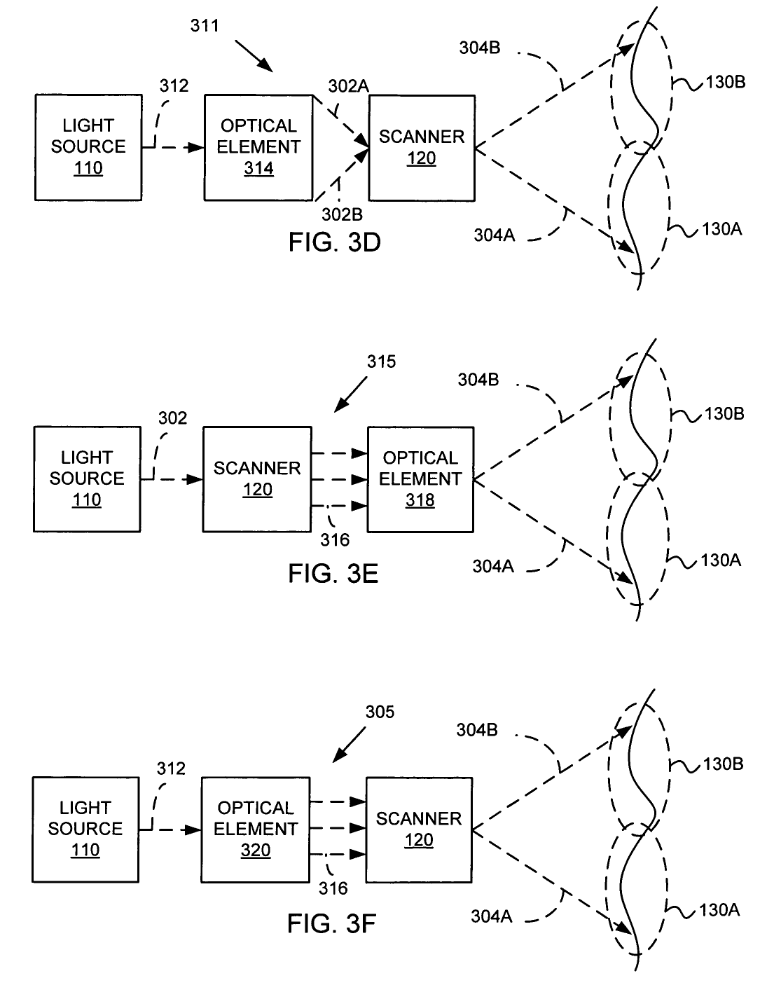

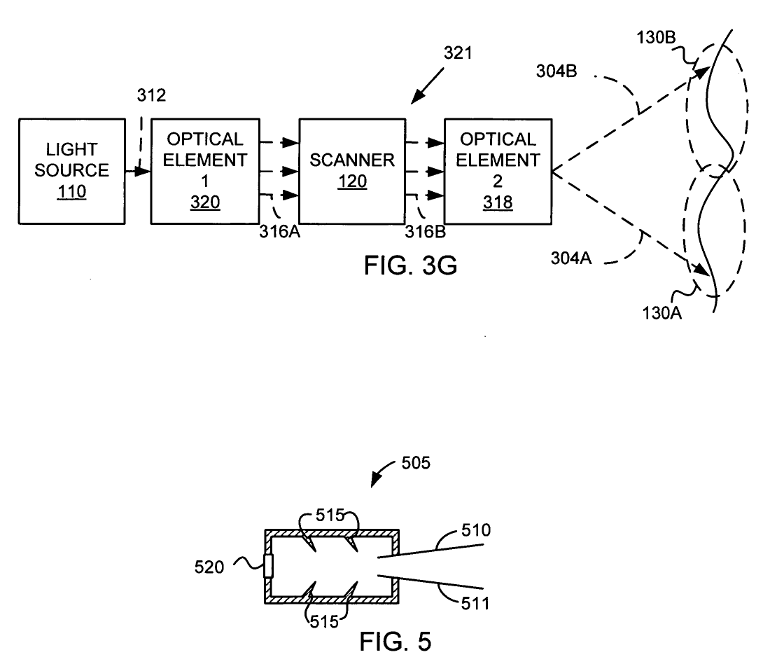

As indicated above, a plurality of scanned beams may alternatively be produced using one scanner. FIG. 3A is a diagram illustrating a structure 301 for generating a plurality of scanning beams from one scanner, according to an embodiment. Two light sources 110a and 110b are operable to produce respective beams of light 302a, 302b. A scanner 120 is aligned to receive the beams 302a, 302b and scan the beams as corresponding scanned beams 304a, 304b across respective scanning zones 130a, 130b.

For a scanner 120 having 1:1 angular reproduction, the converging angle made between emitted beams 302a and 302b is preserved as a diverging angle between scanning beams 304a, 304b. The light sources and the scanner may be constructed according to a range of embodiments such as lasers with a reflective, refractive, or diffractive scanner, scanned fibers moved by a common actuator mechanism, etc. In some embodiments, the light sources are multi-wavelength laser, collimator, and beam-combiner assemblies, beams 302a, 302b are composite beams including red, green, and blue wavelength components, and the scanner is a biaxial MEMS scanner.

FIG. 3B is a diagram illustrating a structure 305 for generating a plurality of scanning beams, according to another embodiment. A light source 110 produces a beam of light 302 and projects it to be incident upon a scanner 120. The scanner 120 is aligned to receive the beam of light and configured to scan the beam of light as a scanned beam 306 across an optical element 308. The optical element 308 is configured to split the incident scanned beam into a plurality of scanned output beams 304a, 304b, and direct the scanned output beams toward respective scanning zones 130a, 130b in a field of view.

As is described elsewhere herein, the optical element 308, which may alternatively be referred to as a beam multiplier or a beam multiplying optical element, may be constructed according to various embodiments. For example the optical element 308 may include one or more diffraction gratings, one or more microlens arrays, lenses, mirrors, diffusers, etc. according to the preferences of the system designer. The operation of microlens arrays in particular is described more fully below.

FIG. 3C is a diagram illustrating a structure 309 for generating a plurality of scanning beams, according to another embodiment. A light source 110 produces a beam of light 302 that impinges onto a scanner 120. The scanner is configured with a beam multiplier such that the incident beam of light is split into plural output beams of light 304a, 304b. The beam multiplier or other portions of the scanner 120 are operated to scan output beams 304a, 304b across respective scanning zones 130a, 130b of a field of view. For example, the scanner may include a diffraction grating or a microlens array over a mirror or integral with a mirror.

FIG. 3D is a diagram illustrating a structure 311 for generating a plurality of scanning beams, according to another embodiment. A light source 110 is configured to produce a beam of light 312 that is made incident upon an optical element 314. The optical element 314 splits the input beam 312 into plural beams 302a, 302b. Beams 302a, 302b are projected at a converging propagation angle toward the scanner 120, which scans the beams as corresponding output scanned beams 304a, 304b toward respective scanning zones 130a, 130b of a field of view.

A diverging angle may be maintained between output scanned beams 304a, 304b corresponding to the converging angle between the input beams 302a, 302b. Alternatively (and also for at least many other embodiments described herein), the output scanned beams 304a, 304b may be parallel or converging, or be produced at a diverging angle differing from the angle of convergence of the input beams 302a, 302b. Thus, the structure 120 indicated “scanner” may include an optical assembly (not shown) to condition, reflect, refract, collimate, or otherwise affect the input beams (here 302a, 302b) or output beams 304a, 304b prior to propagation toward the scanning zones.

FIG. 3E is a diagram illustrating a structure 315 for generating a plurality of scanning beams, according to another embodiment. A light source 110 projects a beam of light 302 toward a scanner 120. The scanner 120 may include an optical element configured to cooperate with another optical element 318 to produce a plurality of scanning beams 304a, 304b that are propagated toward respective zones 130a, 130b of a field of view. The optical element of the scanner 120 is configured to provide scanned intermediate beamlets 316 to the optical element 318, which in turn converts the intermediate beamlets 316 into scanned output beams 304a, 304b.

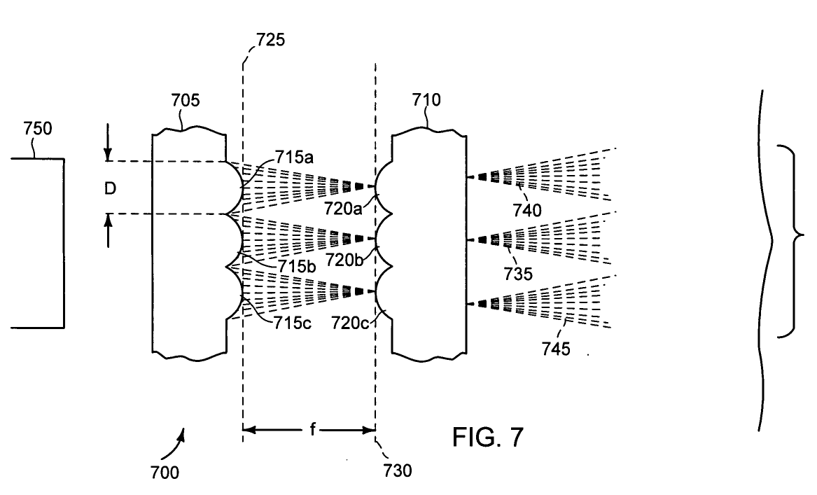

For example, the scanner optical element and the optical element 318 may operate cooperatively in a manner akin to that described in conjunction with FIG. 7, 8, or 9. That is, a microlens array 705 may be incorporated with the scanner 120 to produce beamlets 316 focused at a distance substantially corresponding to the distance to the optical element 318. The optical element 318 may include a second microlens array 710 configured to receive the beamlets and output corresponding scanned output beams 304a, 304b.

FIG. 3F is a diagram illustrating a structure 319 for generating a plurality of scanning beams, according to another embodiment. A light source 110 is configured to illuminate an optical element 320 with a beam of light 312. The optical element 320 is configured to convert the input beam into intermediate beamlets 316. The input beamlets are received by the scanner 120, which includes another optical element configured to convert the intermediate beamlets 316 into output beams 314a, 314b. As with other embodiments described herein, output beams 314a, 314b are scanned across respective zones 130a, 130b of a field of view.

FIG. 3G is a diagram illustrating a structure for generating a plurality of scanning beams, according to another embodiment. A light source 110 outputs a beam of light 312 that impinges upon a first optical element 320. The first optical element 320 is configured to split incident light into a plurality of intermediate beamlets 316a and direct the intermediate beamlets toward a scanner 120. The scanner 120 may have a mirror surface and be operable to scan the intermediate beamlets 316b across a second optical element 318 configured to convert the scanned intermediate beamlets 316b into a plurality of scanned beams 304a, 304b and direct the scanned beams toward corresponding scanning zones 130a, 130b of a field of view. The first and second optical elements may include microlens arrays with lenslets having a focal length, and the first and second optical elements may, for example, be separated from one another by an optical propagation distance substantially equal to the focal length. Other optical elements such as fixed mirrors, prisms, telecentric lenses, etc. may cooperate to converge the first intermediate beamlets 316a onto the scanner surface and subsequently collimate the scanned intermediate beamlets 316b for receipt by the second optical element 318.

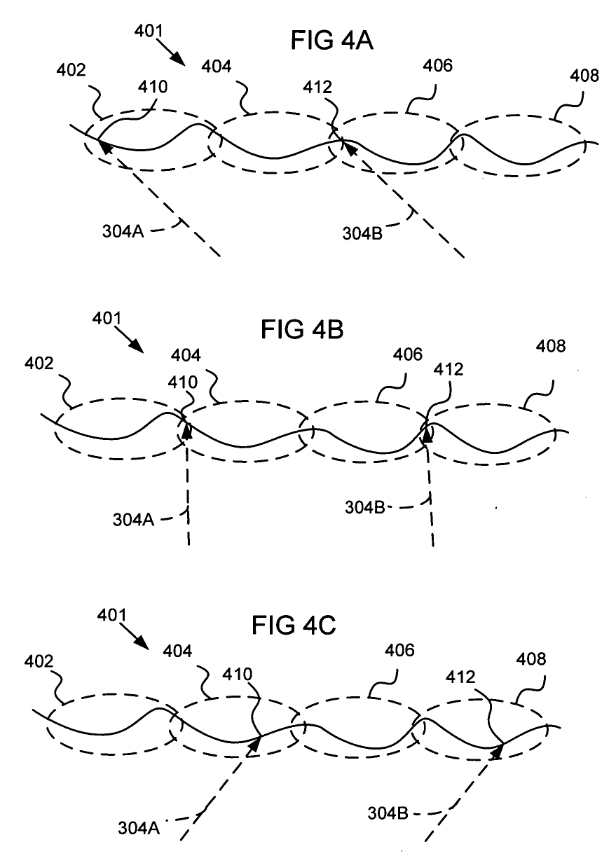

According to an embodiment, the relationship between scanned zones and detection zones may be other than 1:1. For example, a beam may be scanned across a scanning zone that traverses detection zones corresponding to a plurality of detectors. FIGS. 4A-4C are simplified depictions of such an illustrative arrangement.

In FIG. 4A, a one-dimensional field of view 401 is comprised of four detection zones 402, 404, 406, and 408. Two instantaneous beam locations 410 and 412 are shown on the field of view, with beam location 410 lying within detection zone 402 and beam location 412 lying within detection zone 406 and at the very edge of detection zone 404. With the scanning beams in the positions shown, a detector corresponding to detection zone 402 may be selected to detect light scattered from the beam spot 410, and a detector corresponding to detection zone 406 may be selected to detect light scattered from the beam spot 412.

FIG. 4B corresponds to a later instant in time when the scanned beams have partially traversed their respective scanning zones of the field of view 401, with beam spot 410 now lying within an overlap between detection zones where scattered light is detected by detectors corresponding to detection zones 402 and 404. Similarly, beam spot 412 has traversed the field of view 401 to a position within both detection zones 406 and 408. In the positions illustrated by FIG. 4B, light scattered from spot 410 may be received and detected by either a detector corresponding to detection zone 402 or by a detector corresponding to detection zone 404. The controller may select a detector channel based, for example, on measured signal strength or other criteria. According to an embodiment, detector values for spots corresponding to such overlaps between detection zones may be averaged or otherwise combined, for example to improve signal-to-noise.

In some embodiments, detector sensitivity may not be equal across the entirety of a detection zone, but may rather decrease somewhat at the edges of the detection zone. In such a case, the controller may apply an equalization algorithm to adjust pixel values to compensate for such systematic variations in detector gain.

Proceeding to FIG. 4C, corresponding to a still later instant in time, spot 410 lies within detection zone 404 and spot 412 lies within detection zone 408. At such an instant light from spots 410 and 412 are respectively detected by detectors corresponding to detection zones 404 and 408.

FIG. 5 is a side view of an illustrative detector that detects light from a zone in a field of view, according to an embodiment. The detector 505 may be oriented toward the area of interest and may receive light within the light cone defined by lines 510 and 511. Note that the detector 505 may detect light scattered toward the detector within the area defined by lines 510 and 511 (which may extend to a field of view). The lines 510 and 511 are illustrated to show the detectable zone of the detector 505 and are not actually part of the detector 505.

Baffles 515 may also be provided to limit the numerical aperture of the detector 505 to the area of interest. The arrangement of baffles 515 is illustrative, and it will be recognized that more, fewer, or different shaped baffles may be used depending on the geometry of the detector 505 and the intended field of view. The detector 505 may be coupled to a light conducting element (not shown) such as an optical fiber at an end 520 so as to transmit detected light to a remote detection unit capable of creating electrical signals corresponding to the detected light.

It will be recognized that the field of view of a detector may be constructed via a plurality of other mechanisms without departing from the spirit or scope of the subject matter described herein.

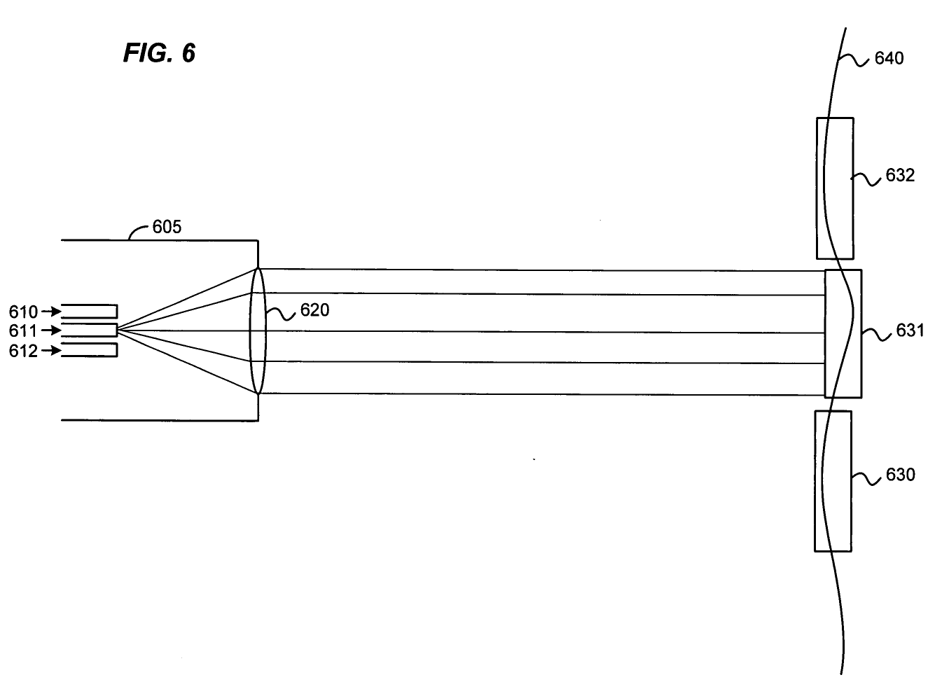

FIG. 6 is a diagram that generally represents another illustrative mechanism for detecting light from various zones according to an embodiment. A light collection assembly 605 includes a lens 620 arranged to focus light scattered from zones 630, 631, and 632 onto fiber ends 612, 611, and 610, respectively. The lens 620 may be selected to have a focal length such that light scattered from the field of view 640 forms as a conjugate image within the collection assembly 605. Detectors or fiber ends 610-612 leading to detectors may be placed in the conjugate image plane. A detector may be sampled at a frequency corresponding to a scanning light spot size and its scanning speed across the field of view 640. In an embodiment, this sampling frequency is 50 MHz. To obtain the same resolution image and frame rate as a single beam scanned-beam system, the sampling frequency may be reduced in proportion to the number of zones.

The optical elements for producing plural beams may include one or more beamlet-producing optical elements such as a diffraction grating, a microlens array (MLA), a dual microlens array (DMLA), etc. An optical element may be embodied as a reflective element, or may be embodied as a transmissive element. Some embodiments are illustrated in FIGS. 7-9.

FIG. 7 is a simplified side view of an illustrative optical element for producing a plurality of beams from an input beam according to an embodiment. A dual-microlens array (DMLA) 700 includes first and second microlens arrays (MLAs) 705 and 710, which are made from a transparent optical material such as plastic or glass and which include a number of lenslets 715 and 720, respectively. The lenslets of MLA 705 lie on a plane 725 and have a focal length f. Likewise, the lenslets of MLA 710 lie on a plane 730, and have the same focal length f. The MLAs 705 and 710 are positioned such that the planes of the lenslet arrays 725 and 730 are separated by the distance f, equal to the focal lengths. In some embodiments, gap between the MLAs is filled with air. Lenslets 715 and 720 have a width D, which is the pitch of the MLAs 705 and 710, and each lenslet 715 is aligned with a corresponding lenslet 720.

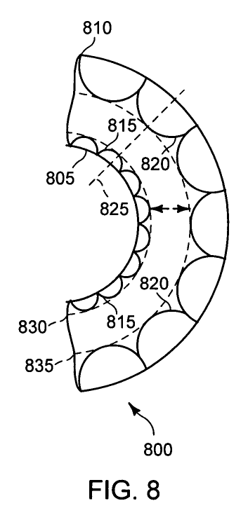

Before striking the DLMA 700, incident light may pass through a collimating lens (not shown) such as a telecentric lens. In another embodiment, the DLMA 700 may be formed as shown in FIG. 8 and a collimating lens may be omitted.

FIG. 8 is a side view of a curved DMLA according to an embodiment. The DMLA 800 includes curved MLAs 805 and 810, which respectively include lenslets 815 and 820. Corresponding pairs of lenslets 815 and 820 are aligned such that incident light rays follow radial paths 825. The MLAs 805 and 810 each have the same focal length f in the radial dimension, and the lenslet arrays lie on respective curved planes 830 and 835, which are spaced apart by f in the radial dimension.

Returning to FIG. 7, in the far field, the beams 735, 740, and 745 may interfere to create a plurality of beamlets. In an embodiment, the size of the beamlet aperture may depend on the wavelength of the beam 750 that strikes the MLA 705. These beamlets are scanned across respective areas as the received beam 750 is scanned across the DLMA 700.

In another embodiment, the optical element shown in FIGS. 7 and 8 may comprise one or more diffraction gratings replacing one or both of the MLAs. Such a diffraction grating may be formed, for example, via reactive ion etching in quartz.

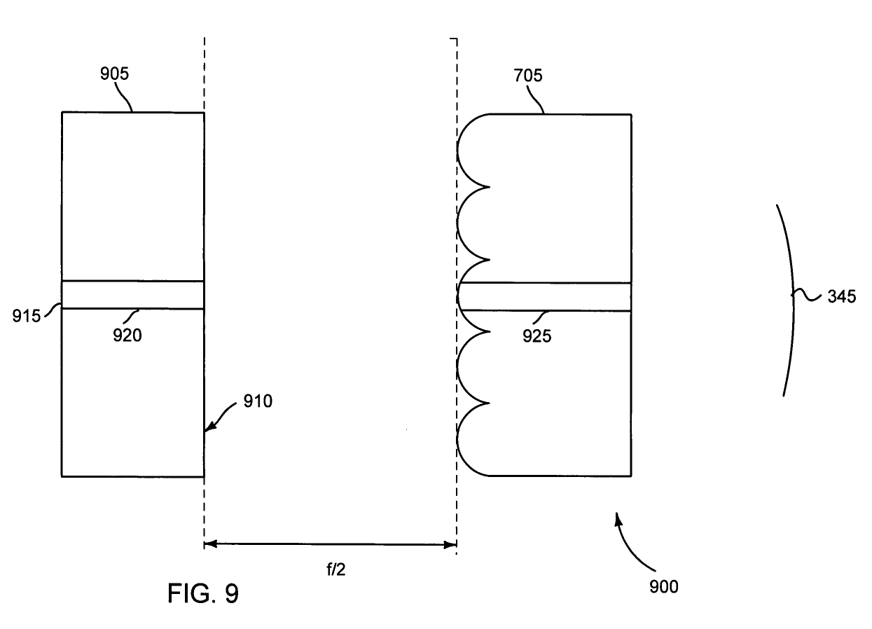

FIG. 9 is a side view of a reflective DMLA according to another embodiment. Like the DMLA 700 of FIG. 7, the DMLA 900 includes the MLA 705. Instead of including another MLA (e.g., MLA 710), however, the DMLA 900 includes a mirror 905. The mirror 905 includes a reflecting surface 910 that is located f/2 from the plane of the lenslets.

While scanned-beam systems having a small number of zones have been described, it will be recognized that the principles described herein may be extended tens, hundreds, thousands, or more zones. The scanned light may be split into beamlets along multiple dimensions to form a 1×2, 2×2, 2×3, 3×3, or other dimensional matrix (e.g., contiguous set of zones) as desired. This may involve passing the light through multiple optical elements, for example.

Light beams suitable for scanning inside a living organism (such as a human being) may have the intensity selected such that they are non-damaging or acceptably damaging to the tissue of the living organism.

The foregoing detailed description has set forth some embodiments via the use of block diagrams, flow diagrams, or examples. Insofar as such block diagrams, flow diagrams, or examples are associated with one or more actions, functions, or operations, it will be understood by those within the art that each action, function, or operation or set of actions, functions, or operations associated with such block diagrams, flowcharts, or examples may be implemented, individually or collectively, by a wide range of hardware, software, firmware, or virtually any combination thereof.

As can be seen from the foregoing detailed description, a range of alternative embodiments may embody the spirit and scope of the subject matter presented herein. While some embodiments have been described in detail, others may be omitted for the sake of clarity. Accordingly, the scope of the invention shall not be limited by the illustrative embodiments, but rather shall extend to the broadest valid interpretation of the claims appended hereto.

What is claimed is:

1. A scanned beam imager comprising:
at least one light source operable to launch emitted light as at least one light beam;
an optical element configured to split the light beam into a plurality of beamlets; and
a beam scanner operable to scan the light beam or the plurality of beamlets in a pattern;
wherein the plurality of beamlets are arranged to concurrently scan a corresponding plurality of zones of a field of view in the pattern.

2. The scanned beam imager of claim 1, further comprising:
a plurality of light collection elements configured to receive light scattered from the corresponding plurality of zones.

3. The scanned beam imager of claim 2, wherein the plurality of light collection elements comprise a plurality of detection optical fibers arranged at a distal tip of a scanning endoscope, the plurality of detection optical fibers comprising optical fibers operative to receive the scattered light through respective numerical apertures less than a numerical aperture corresponding to the entire field of view and arranged to at least preferentially receive scattered light from one of the corresponding zones.

4. The scanned beam imager of claim 2, wherein the plurality of light collection elements comprises:
an array of vignetted light collectors configured to substantially exclude light scattered from more than one zone from reaching any one of the array of light collectors, during at least a portion of the scan pattern.

5. The scanned beam imager of claim 1, further comprising:
a plurality of light detectors configured to receive light from the corresponding plurality of zones and responsively produce corresponding detection signals; and
an image processor operatively coupled to receive the detection signals and operable to construct an image from the detection signals.

6. The scanned beam imager of claim 1 wherein the light source includes an optical fiber configured to deliver the emitted light to a distal tip of a scanning endoscope.

7. The scanned beam imager of claim 1 wherein the optical element is aligned to receive the light beam from the light source and configured to launch beamlets toward the beam scanner.

8. The scanned beam imager of claim 7 wherein the beamlets include converging beamlets that are received by the beam scanner and scanned by the beam scanner as diverging beams.

9. The scanned beam imager of claim 7 wherein the beamlets include intermediate beamlets that are received by the beam scanner and scanned by the beam scanner as scanned intermediate beamlets; and further comprising:
a second optical element aligned to receive the scanned intermediate beamlets and configured to convert the scanned intermediate beamlets into the scanned output beamlets.

10. The scanned beam imager of claim 7 wherein the beamlets include intermediate beamlets that are received by the beam scanner; and
wherein the beam scanner includes a second optical element configured to convert the received intermediate beamlets into the plurality of output beamlets substantially concurrently with scanning.

11. The scanned beam imager of claim 1 wherein the optical element is aligned to receive the scanned light beam from the beam scanner and configured to launch correspondingly scanned beamlets toward the field of view.

12. The scanned beam imager of claim 1, wherein the optical element comprises at least one selected from the group consisting of a diffraction grating, a transmissive diffraction grating, a reflective diffraction grating, a microlens array, a dual microlens array, a transmissive microlens array, a reflective microlens array, a holographic element, a meniscus lens comprising at least one surface with lenslets disposed thereon, a converging beamlet producing element, and a diverging beamlet producing element.

13. The scanned beam imager of claim 1 wherein the beam scanner comprises a moving surface and wherein a second optical element is disposed on the moving surface.

14. The scanned beam imager of claim 1 wherein the light beam launched by the light source comprises a plurality of wavelengths.

15. The scanned beam imager of claim 1 wherein the beamlets are scanned concurrently.

16. A method for scanning a field of view, comprising:
emitting a beam of light;
splitting the beam of light into a plurality of beamlets; and
scanning the beamlets across corresponding zones in a field of view.

17. The method of claim 16, further comprising:
receiving light scattered from the plurality of zones.

18. The method of claim 17, wherein the light is received substantially separately from the plurality of zones.

19. The method of claim 17, further comprising:
converting the received light into corresponding detection signals; and
processing the detection signals into an image spanning a plurality of the zones.

20. The method of claim 19, wherein the light is split into the plurality of beamlets prior to impinging upon the beam scanner.

21. The method of claim 19, wherein the light is split into the plurality of beamlets after the light is scanned by the beam scanner.

22. The method of claim 19, wherein the light is split into a plurality of beamlets substantially concurrently with scanning by the beam scanner.

23. The method of claim 19, wherein the light comprises a plurality of wavelengths.

24. The method of claim 16, wherein the beamlets are scanned concurrently.

25. A scanned beam imager, comprising:
at least two light sources operable to launch emitted light as at least two light beams;
a beam scanner configured to receive and scan the at least two light beams in respective patterns in respective scanning zones; and
a controller operable to modulate the light sources to control the delivery of the light beams to the scanning zones.

26. The scanned beam imager of claim 25, further comprising:
at least one detector configured to receive scattered light from the scanning zones and output a detection signal; and wherein the controller is further operable to attribute the detection signal to a corresponding scanning zone.

27. A method for generating an image of a field of view, comprising:
sequentially modulating a plurality of light sources to produce a corresponding plurality of modulated beams;
scanning the modulated beams across corresponding scanning zones with a beam scanner; and
detecting light scattered from the scanning zones and forming a corresponding detection signal comprising a sequence of values corresponding to a sequence of scanning zones.

28. The method of claim 27, further comprising:
determining a sequence of scattered light values from the detection signal; and
loading data into electronic memory corresponding to the scattered light values at locations corresponding to the sequence of light source modulation and position of the beam scanner.

29. A scanned beam endoscope comprising a tip having a proximal end and a distal end, wherein the tip comprises:
an illumination optical fiber configured to receive illumination light at the proximal end and transmit the illumination light to the distal end;
a beam shaping optical element configured to receive the illumination light and launch an illumination beam;
a beam scanner disposed at the distal end and operable to receive the illumination beam and scan the illumination beam in a pattern as a scanned beam; and
a beam splitter disposed at the distal end and configured to split one of the illumination beam or the scanned beam into beamlets.

30. The scanned beam endoscope of claim 29, wherein the beam shaping optical element is integral with the illumination optical fiber.

31. The scanned beam endoscope of claim 29, wherein the beam splitter is integral with the beam shaping optical element.

32. The scanned beam endoscope of claim 29, wherein the beam splitter is integral with the beam scanner.

33. The scanned beam endoscope of claim 29, wherein the tip further comprises an array of detection optical fibers configured to receive light from the beamlets scattered by an object at the distal end such that scattered light from each beamlet is uniquely distributed across the detection optical fibers, and transmit the received light to the proximal end.

34. The scanned beam endoscope of claim 29, wherein uniquely distributed comprises being substantially isolated to one or more of the detection optical fibers at any instant in time.
